(19) United States
(12) Patent Application Publication
(10) Pub. No.: US 2009/0186781 A1
(43) Pub. Date: Jul. 23, 2009

(54) Drilling fluids comprising sub-micron precipitated barite as a component of the weighting agent and associated methods

(75) Inventor: Ying Zhang, Sugar Land, TX (US)

Correspondence Address: CRAIG W. RODDY;HALLIBURTON ENERGY SERVICES, P.O. BOX 1431, DUNCAN, OK, 73536-0440, US

(73) Assignee: HALLIBRUTON ENERGY SERVICES, INC., a Delaware Corporation, Houston, TX (US)

(21) Appl. No.: 12/015,696

(22) Filed: Jan. 17, 2008

(51) Int. Cl. C09K 8/16

(52) U.S. Cl. 507/140

(57) ABSTRACT

An embodiment of the present invention includes a method comprising circulating a drilling fluid in a well bore, wherein the drilling fluid comprises a carrier fluid; and a weighting agent that comprises precipitated barite having a weight average particle diameter below about 1 micron and a particle having a specific gravity of greater than about 2.6. Another embodiment of the present invention includes a drilling fluid comprising: a carrier fluid; and a weighting agent that comprises precipitated barite having a weight average particle diameter below about 1 micron, and a particle having a specific gravity of greater than about 2.6. Another embodiment of the present invention includes a weighting agent that comprises precipitated barite having a weight average particle diameter below about 1 micron, and a particle having a specific gravity of greater than about 2.6.

### BACKGROUND

The present invention relates to compositions and methods for drilling well bores in subterranean formations. More particularly, in certain embodiments, the present invention relates to drilling fluids that comprise sub-micron precipitated barite as a component of the weighting agent.

Natural resources such as oil or gas residing in a subterranean formation can be recovered by drilling a well bore that penetrates the formation. During the drilling of the well bore, a drilling fluid may be used to, among other things, cool the drill bit, lubricate the rotating drill string to prevent it from sticking to the walls of the well bore, prevent blowouts by serving as a hydrostatic head to the entrance into the well bore of formation fluids, and remove drill cuttings from the well bore. A drilling fluid may be circulated downwardly through a drill pipe and drill bit and then upwardly through the well bore to the surface.

In order to prevent formation fluids from entering the well bore, the hydrostatic pressure of the drilling fluid column in the well bore should be greater than the pressure of the formation fluids. The hydrostatic pressure of the drilling fluid column is a function of the density of the drilling fluid and depth of the well bore. Accordingly, density is an important property of the drilling fluid for preventing the undesirable flow of formation fluids into the well bore. To provide increased density, weighting agents are commonly included in drilling fluids. Weighting agents are typically high-specific gravity, finely ground solid materials. As referred to herein, the term “high-specific gravity” refers to a material having a specific gravity of greater than about 2.6. Examples of suitable weighting agents include, but are not limited to, barite, hematite, ilmentite, manganese tetraoxide, galena, and calcium carbonate.

As well bores are being drilled deeper, the pressure of the formation fluids increases. To counteract this pressure increase and prevent the undesired inflow of formation fluids, a higher concentration of weighting agent may be included in the drilling fluid. However, increasing the concentration of weighting agent may be problematic. For example, as the concentration of the weighting agent increases problems with particle sedimentation may occur (often referred to as “sag”). Among other things, particle sedimentation may result in stuck pipe or a plugged annulus. Particle sedimentation may be particularly problematic in directional drilling techniques, such as horizontal drilling. In addition to particle sedimentation, increasing the concentration of the weighting agent also may undesirably increase the viscosity of the drilling fluid, for instance. While viscosification of the drilling fluid may be desired to suspend drill cuttings and weighting agents therein, excessive viscosity may have adverse effects on equivalent circulating density. For example, an undesirable increase in the equivalent circulating density may result in an undesired increase in pumping requirements for circulation of the drilling fluid in the well bore.

Several techniques have been utilized to prevent undesired particle sedimentation while providing a drilling fluid with desirable Theological properties. For instance, decreasing the particle size of the weighting agent should create finer particles, reducing the tendency of the particles to settle. However, the inclusion of too many particles of a reduced particle size typically causes an undesirable increase in viscosity. Accordingly, the use of particle sizes below 10 microns has typically been avoided. This is evidenced by the API specification for barite as a drilling fluid additive, which limits the % w/w of particles below 6 microns to a 30% w/w maximum to minimize viscosity increase.

One approach to reducing particle size while maintaining desirable rheology involves utilizing particles of a reduced size while avoiding too many particles that are too fine (below about 1 micron). For instances, sized weighting agents have been utilized with a particle size distribution such that at least 90% of the cumulative volume of the measured particle size diameter is approximately between 4 microns and 20 microns, with a weight average particle diameter (“d₅₀”) of approximately between 1 micron to 6 microns. The sizing process, however, undesirably increases the material and energy costs involved with sized weighting agent. Another approach to reducing particle size while maintaining desirable rheology involves comminuting the weighting agent in the presence of a dispersant to produce particles coated with the dispersant. The weighting agent is comminuted to have a d₅₀ below 2 microns to 10 microns. It is reported that the coating on the comminuted particles prevents the undesired viscosity increase that would be expected from use of particles with a reduced size. However, the coating and comminuting processes add undesired complexity and material and energy costs to utilization of the weighting agent.

### SUMMARY

The present invention relates to compositions and methods for drilling well bores in subterranean formations. More particularly, in certain embodiments, the present invention relates to drilling fluids that comprise sub-micron precipitated barite as a component of the weighting agent.

In one embodiment, the present invention provides a method comprising: circulating a drilling fluid in a well bore, wherein the drilling fluid comprises a carrier fluid; and a weighting agent that comprises precipitated barite having a weight average particle diameter below about 1 micron and a particle having a specific gravity of greater than about 2.6.

In another embodiment, the present invention provides a method comprising: extending a well bore into a subterranean formation; and circulating an invert-emulsion drilling fluid past a drill bit in the well bore, wherein the invert-emulsion drilling fluid comprises a weighting agent comprising precipitated barite having a weight average particle diameter below about 1 micron and a particle having a specific gravity of greater than about 2.6.

In another embodiment, the present invention provides a drilling fluid comprising: a carrier fluid; and a weighting agent that comprises precipitated barite having a weight average particle diameter below about 1 micron, and a particle having a specific gravity of greater than about 2.6.

In another embodiment, the present invention provides a weighting agent that comprises precipitated barite having a weight average particle diameter below about 1 micron, and a particle having a specific gravity of greater than about 2.6.

The features and advantages of the present invention will be readily apparent to those skilled in the art. While numerous changes may be made by those skilled in the art, such changes are within the spirit of the invention.

### DESCRIPTION OF PREFERRED EMBODIMENTS

The present invention relates to compositions and methods for drilling well bores in subterranean formations. More particularly, in certain embodiments, the present invention relates to drilling fluids that comprise sub-micron precipitated barite as a component of the weighting agent.

There may be several potential advantages to the methods and compositions of the present invention. Surprisingly, use of sub-micron precipitated barite as a component of the weighting agent, in accordance with embodiments of the present invention, may provide a drilling fluid having a desired density without an undesired increase in viscosity. For instance, inclusion of the sub-micron precipitated barite in the weighting agent may inhibit particle sedimentation, while proper adjustment of the fluid formulation reduces, or even eliminates, the undesirable impact on viscosity or fluid-loss control that would typically be expected from the use of fine particles. Another potential advantage is that inclusion of sub-micron precipitated barite as a component of the weighting agent may enhance the emulsion stability of certain drilling fluids. Yet another potential advantage is that the sub-micron precipitated barite may be used as a viscosifying agent, in addition to a weighting agent, reducing or eliminating the need for viscosifying agents in the drilling fluid.

In accordance with embodiments of the present invention, a drilling fluid may comprise a carrier fluid and a weighting agent that comprises sub-micron precipitated barite and a particle having a specific gravity of greater than about 2.6. In general, the drilling fluid may have a density suitable for a particular application. By way of example, the drilling fluid may have a density of greater than about 12 pounds per gallon (“lb/gal”). In certain embodiments, the drilling fluid may have a density of about 16 lb/gal to about 22 lb/gal.

Carrier fluids suitable for use in the drilling fluids include any of a variety of fluids suitable for use in a drilling fluid. Examples of suitable carrier fluids include, but are not limited to, aqueous-based fluids (e.g., water, oil-in-water emulsions), oleaginous-based fluids (e.g., invert emulsions). In certain embodiments, the aqueous fluid may be foamed, for example, containing a foaming agent and entrained gas. In certain embodiments, the aqueous-based fluid comprises an aqueous liquid. Examples of suitable oleaginous fluids that may be included in the oleaginous-based fluids include, but are not limited to, α-olefins, internal olefins, alkanes, aromatic solvents, cycloalkanes, liquefied petroleum gas, kerosene, diesel oils, crude oils, gas oils, fuel oils, paraffin oils, mineral oils, low-toxicity mineral oils, olefins, esters, amides, synthetic oils (e.g., polyolefins), polydiorganosiloxanes, siloxanes, organosiloxanes, ethers, acetals, dialkylcarbonates, hydrocarbons, and combinations thereof. In certain embodiments, the oleaginous fluid may comprise an oleaginous liquid.

Generally, the carrier fluid may be present in an amount sufficient to form a pumpable drilling fluid. By way of example, the carrier fluid may be present in the drilling fluid in an amount in the range of from about 20% to about 99.99% by volume of the drilling fluid. One of ordinary skill in the art with the benefit of this disclosure will recognize the appropriate amount of carrier fluid to include within the drilling fluids of the present invention in order to provide a drilling fluid for a particular application.

In addition to the carrier fluid, a weighting agent may also be included in the drilling fluid, in accordance with embodiments of the present invention. The weighting agent may be present in the drilling fluid in an amount sufficient for a particular application. For example, the weighting agent may be included in the drilling fluid to provide a particular density. In certain embodiments, the weighting agent may be present in the drilling fluid in an amount up to about 50% by volume of the drilling fluid (v %) (e.g., about 5%, about 15%, about 20%, about 25%, about 30%, about 35%, about 40%, about 45%, etc.). In certain embodiments, the weighting agent may be present in the drilling fluid in an amount of 10 v % to about 40 v %.

In accordance with embodiments of the present invention, the weighting agent may comprise sub-micron precipitated barite. Sub-micron precipitated barite was observed via a scanning electron microscope (“SEM”) to be generally more spherical and less angular than API barite. The precipitated barite may be formed in accordance with any suitable method. For example, barium sulfate can be precipitated from a hot, acidic, dilute barium chloride solution by adding dilute sodium sulfate solution. Other techniques for preparing precipitated barite also may be suitable. The sub-micron precipitated barite generally has a d₅₀ of less than about 1 micron. In certain embodiments, the sub-micron precipitated barite has a particle size distribution such that at least 90% of the particles have a diameter (“d₉₀”) below about 1 micron. In certain embodiments, the sub-micron precipitated barite has a particle size distribution such that at least 10% of the particles have a diameter (“d₁₀”) below about 0.2 micron, 50% of the particles have a diameter (“d₅₀”) below about 0.3 micron and 90% of the particles have a diameter (“d₉₀”) below about 0.5 micron. Particle size distributions of the sub-micron precipitated barite were analyzed statistically from a representative SEM image. An example of a suitable sub-micron precipitated barite is “Barium Sulfate Precipitated” available from Guangxi Xiangzhou Lianzhuang Chemical Co. LTD.

Because the particle size of the precipitated barite is lower than that for particles typically used as weighting agents, the precipitated barite should be more resistant to settling, thus allowing the inclusion of higher concentrations in a drilling fluid. As noted above, however, inclusion of too many fine particles in a drilling fluid is expected to have an undesirable impact on the fluid's viscosity. Surprisingly, use of sub-micron precipitated barite as a component of the weighting agent, in accordance with embodiments of the present invention, may provide a drilling fluid having a desired density without an undesired increase in viscosity. For instance, inclusion of the sub-micron precipitated barite in the weighting agent while properly adjusting the fluid formulation may improve particle sedimentation without the undesirable impact on viscosity or fluid-loss control that would typically be expected from the use of fine particles. In addition, the precipitated barite may improve the emulsion stability of certain drilling fluids. For example, certain weighting agent components (such as manganese tetraoxide) may undesirably impact the stability of water-in-oil emulsions. However, the inclusion of the precipitated barite as a component of the weighting agent may counteract this emulsion destabilization creating a more stable, long-term emulsion. It is believed that the precipitated barite enhances the emulsion stability by creating densely populated, ultra-fine emulsion droplets in the invert emulsion for oil-based drilling fluids. Furthermore, in certain embodiments, the sub-micron precipitated barite may be used as a viscosifying agent, in addition to a weighting agent, reducing or eliminating the need for viscosifying agents in the drilling fluid. As conventional viscosifying agents, such as organophilic clay, may have undesirable impacts on fluid stability under extreme high pressure, high temperature (“HPHT”) environments, their elimination may produce more stable fluids.

The sub-micron precipitated barite may be present in the weighting agent in an amount sufficient for a particular application. By way of example, the sub-micron precipitated barite may be present in the weighting agent in an amount of about 10% to about 90% by weight (e.g., about 20%, about 30%, about 40%, about 50%, about 60%, about 70%, about 80%, etc.). The amount of the sub-micron precipitated barite to include in the weighting agent depends on a number of factors, including the desired particle sedimentation rate, fluid viscosity, density, filtration control and economical considerations.

As mentioned above, the weighting agent also comprises a particle having a specific gravity of greater than about 2.6. In certain embodiments, the particle may have a specific gravity of greater than about 4. The high-specific-gravity particle may comprise any of a variety of particles suitable for increasing the density of a drilling fluid. For example, the high-specific-gravity particles may comprise barite, hematite, ilmentite, manganese tetraoxide, galena, and calcium carbonate. Combinations of these particles may also be used. In one embodiment, the high-specific-gravity particle comprises manganese tetraoxide in an amount of greater than 90% by weight of the particle. Examples of high-specific-gravity particles that comprise manganese tetraoxide include MICROMAX™ and MICROMAX FF™ weighting materials, available from Elkem Materials Inc.

The particle having a specific gravity of greater than about 2.6 may be present in the weighting agent in an amount sufficient for a particular application. By way of example, the high-specific-gravity particle barite may be present in the weighting agent in an amount of about 10% to about 90% by weight (e.g., about 20%, about 30%, about 40%, about 50%, about 60%, about 70%, about 80%, etc.). The amount of the high-specific-gravity particle to include in the weighting agent depends on a number of factors, including the desired particle sedimentation rate, fluid viscosity, density, filtration control and economical considerations.

The ratio of the sub-micron precipitated barite to the high-specific-gravity particle included in the weighting agent depends, among other things, on cost, the desired properties of the drilling fluid, and the like. In certain embodiment, the sub-micron-precipitated-barite-to-high-specific-gravity-particle ratio may be about 10:90 to about 90:10 (e.g., about 20:80, about 30:70, about 40:60, about 50:50, about 40:60, about 30:70, about 80:20, etc.).

In addition, the drilling fluid may further comprise a viscosifying agent in accordance with embodiments of the present invention. As used herein the term “viscosifying agent” refers to any agent that increases the viscosity of a fluid. By way of example, a viscosifying agent may be used in a drilling fluid to impart a sufficient carrying capacity and/or thixotropy to the drilling fluid, enabling the drilling fluid to transport drill cuttings and/or weighting materials, prevent the undesired settling of the drilling cuttings and/or weighting materials. As mentioned above, the sub-micron precipitated barite may replace viscosifying agents, in accordance with embodiments of the present invention. However, in certain embodiments, the sub-micron precipitated barite may be used in conjunction with a viscosifying agent.

Where present, a variety of different viscosifying agents may be used that are suitable for use in a drilling fluid. Examples of suitable viscosifying agents, include, but are not limited to, clays and clay derivatives, polymeric additives, diatomaceous earth, and polysaccharides such as starches. Combinations of viscosifying agents may also be suitable. The particular viscosifying agent used depends on a number of factors, including the viscosity desired, chemical compatibility with other fluids used in formation of the well bore, and other well bore design concerns.

The drilling fluids may further comprise additional additives as deemed appropriate by one of ordinary skill in the art, with the benefit of this disclosure. Examples of such additives include, but are not limited to, emulsifiers, wetting agents, dispersing agents, shale inhibitors, pH-control agents, emulsifiers, filtration-control agents, lost-circulation materials, alkalinity sources such as lime and calcium hydroxide, salts, or combinations thereof.

In accordance with embodiments of the present invention, a drilling fluid that comprises a carrier fluid and a weighting agent may be used in drilling a well bore. As set forth above, embodiments of the weighting agent comprise sub-micron precipitated barite and a particle having a specific gravity of greater than about 2.6. In certain embodiments, a drill bit may be mounted on the end of a drill string that may comprise several sections of drill pipe. The drill bit may be used to extend the well bore, for example, by the application of force and torque to the drill bit. A drilling fluid may be circulated downwardly through the drill pipe, through the drill bit, and upwardly through the annulus between the drill pipe and well bore to the surface. In an embodiment, the drilling fluid may be employed for general drilling of well bore in subterranean formations, for example, through non-producing zones. In another embodiment, the drilling fluid may be designed for drilling through hydrocarbon-bearing zones.

To facilitate a better understanding of the present invention, the following examples of certain aspects of some embodiments are given. In no way should the following examples be read to limit, or define, the entire scope of the invention.

### EXAMPLE 1

For this series of tests, several 17.9 lb/gal (2.14 g/cm³) oil-based drilling fluids were prepared using a mixture of precipitated barite and API barite. The fluid density was obtained from a standard analytical balance. The fluids were mixed with a Hamilton Beach multi-mixer over a 1-hour period. An internal brine phase (250,000 ppm calcium chloride) was emulsified into a continuous oil phase (EDC 99 DW, a hydrogenated mineral oil available from Total Fina Elf). The oil-to-water ratio in the sample fluids was 85/15. The amount of the weighting agents was adjusted according to the desired density of the sample fluids. The mixing ratios of precipitated barite to API barite were 90/10, 70/30 and 50/50 by weight for Sample Fluids #1, #2, and #3, respectively. No organophilic clay was used in these sample fluids. Also included in each sample 6 pounds per barrel of (“lb/bbl”) DURATONE® E filtration control agent, available from Halliburton Energy Services, and 5 lb/bbl of a polymeric fluid loss control agent.

Table 1 below shows the viscosity of each sample fluid at various shear rates (in rotations per minute or rpm's), measured with a Fann 35 rheometer at 120° F. Table 1 also includes the result of a high-temperature, high-pressure (“HPHT”) filtration test and sag index after static aging at 45° at 400° F. for 120 hours. Filtration was measured with a saturated API HPHP fluid loss cell. The sag index was calculated from D_{b}/2Dₘ, where D_{b} is the density of the bottom third of the particular sample fluid after static aging and Dₘ is the density of the original fluid. A lower sag index indicates better fluid stability against particle sedimentation. The properties of Sample Fluid #3 were measured after static aging for 72 hours.

TABLE 1

| | Viscosity at various shear rates (rpm of agitation): | | | | | | Plastic | Yield Point, | | |
|---|---|---|---|---|---|---|---|---|---|---|
| | Dial readings of “Fann Units” for: | | | | | | viscosity | lb/100 ft2 | | Filtration |
| # | 600 rpm | 300 rpm | 200 rpm | 100 rpm | 6 rpm | 3 rpm | mPa · s | (Pascals) | Sag Index | ml |
| 1 | 165 | 101 | 78 | 53 | 18 | 16 | 64 | 37 | 0.514 | 22 |
| 2 | 104 | 65 | 51 | 34 | 11 | 9 | 39 | 26 | 0.543 | 10.4 |
| 3 | 97 | 59 | 45 | 29 | 8 | 7 | 38 | 21 | 0.576 | 6.8 |

From the above example, it can be seen that increasing fraction of precipitated barite enhances the stability against particle sedimentation. The accompanied viscosity increase is still acceptable for most drilling operations. The increasing filtration is due to the narrow size distribution of precipitated barite particles.

### EXAMPLE 2

For this series of tests, several 17.9 lb/gal (2.14 g/cm³) oil-based drilling fluids were prepared using a mixture of precipitated barite and API barite. The fluid density was obtained from a standard analytical balance. The fluids were mixed with a Hamilton Beach multi-mixer over a 1-hour period. An internal brine phase (250,000 ppm calcium chloride) was emulsified into a continuous oil phase (EDC 99 DW, a hydrogenated mineral oil available from Total Fina Elf). The oil-to-water ratio in the sample fluids was 80/20. The amount of the weight agents was adjusted according to the desired density of the sample fluids. The mixing ratios of precipitated barite to API barite were 30/70 and 50/50 by weight for Sample Fluids #4 and #5, respectively. No organophilic clay was used in these sample fluids. Also included in each sample were 8 lb/bbl of DURATONE® E filtration control agent, available from Halliburton Energy Services, and 7 lb/bbl of a polymeric fluid loss control agent.

Table 2 below shows the viscosity of each sample fluid at various shear rates, measured with a Fann 35 rheometer at 120° F. Table 2 also includes the result of a HPHT filtration test and sag index after static aging at 45° at 400° F. for 120 hours. Filtration was measured with a saturated API HPHP fluid loss cell. The sag index was calculated from D_{b}/2Dₘ, where D_{b} is the density of the bottom third of the particular sample fluid after static aging and Dₘ is the density of the original fluid.

TABLE 2

| | Viscosity at various shear rates (rpm of agitation): | | | | | | Plastic | Yield Point, | | |
|---|---|---|---|---|---|---|---|---|---|---|
| | Dial readings of “Fann Units” for: | | | | | | viscosity | lb/100 ft2 | | Filtration |
| # | 600 rpm | 300 rpm | 200 rpm | 100 rpm | 6 rpm | 3 rpm | mPa · s | (Pascals) | Sag Index | ml |
| 4 | 121 | 71 | 52 | 32 | 7 | 6 | 50 | 21 | 0.574 | 1.2 |
| 5 | 147 | 90 | 69.5 | 47 | 13 | 10.5 | 57 | 33 | 0.531 | 2.8 |

From the above example, it can be seen that the increasing amount of precipitated barite in Sample 5 enhances fluid stability against sedimentation with no detrimental effect on viscosity and filtration.

### EXAMPLE 3

For this series of tests, several 17.9 lb/gal (2.14 g/cm³) oil-based drilling fluids were prepared. The fluid density was obtained from a standard analytical balance. The fluids were mixed with a Hamilton Beach multi-mixer over a 1-hour period. An internal brine phase (250,000 ppm calcium chloride) was emulsified into a continuous oil phase (EDC 99 DW, a hydrogenated mineral oil available from Total Fina Elf). The oil-to-water ratio in the sample fluids was 80/20. The amount of the weight agents was adjusted according to the desired density of the sample fluids. Sample Fluid #6 (comparative) used manganese tetraoxide (MICROMAX™ weighting material) as the only weighting material and the total of 5 lb/gal of organophilic clay species as the viscosifier. Sample Fluid #7 used a mixture of precipitated barite and MICROMAX™ weighting material at a mixing ratio of 30/70 by weight. No organophilic clay was used in Fluid #7. Also included in each sample were 8 lb/bbl of DURATONE® E filtration control agent, available from Halliburton Energy Services, and a 7 lb/bbl of a polymeric fluid loss control agent.

Table 2 also includes the result of a HPHT filtration test and sag index after static aging at 45° at 400° F. for 120 hours.

Table 3 below shows the viscosity of each sample fluid at various shear rates, measured with a Fann 35 rheometer at 120° F. Table 2 also includes the result of a HPHT filtration test and sag index after static aging at 45° at 400° F. for 60 hours (Sample Fluid #6) and 120 hours (Sample Fluid #7). Filtration was measured with a saturated API HPHP fluid loss cell. The sag index was calculated from D_{b}/2Dₘ, where D_{b} is the density of the bottom third of the particular sample fluid after static aging and Dₘ is the density of the original fluid.

TABLE 3

| | Viscosity at various shear rates (rpm of agitation): | | | | | | Plastic | Yield Point, | | |
|---|---|---|---|---|---|---|---|---|---|---|
| | Dial readings of “Fann Units” for: | | | | | | viscosity | lb/100 ft2 | | Filtration |
| # | 600 rpm | 300 rpm | 200 rpm | 100 rpm | 6 rpm | 3 rpm | mPa · s | (Pascals) | Sag Index | ml |
| 6 | 117 | 72 | 55 | 36 | 11 | 9 | 45 | 27 | 0.54 | 3 |
| 7 | 105 | 64 | 50 | 33 | 10 | 8.5 | 41 | 23 | 0.519 | 3.4 |

The above example clearly illustrates the benefit of blending precipitated barite in fluids containing MICROMAX™ weighting material with increased anti-sagging stability (lower sag index over longer high temperature static aging duration). Additionally, the preferred low viscosity was maintained in Sample No. 7 without using organophilic clay. The filtration control was satisfying.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. In particular, every range of values (of the form, “from about a to about b,” or, equivalently, “from approximately a to b,” or, equivalently, “from approximately a-b”) disclosed herein is to be understood as referring to the power set (the set of all subsets) of the respective range of values, and set forth every range encompassed within the broader range of values. Moreover, the indefinite articles “a” or “an”, as used in the claims, are defined herein to mean one or more than one of the element that it introduces. Also, the terms in the claims have their plain, ordinary meaning unless otherwise explicitly and clearly defined by the patentee.

What is claimed is:

1. A method comprising:
circulating a drilling fluid in a well bore, wherein the drilling fluid comprises:
a carrier fluid; and
a weighting agent that comprises precipitated barite having a weight average particle diameter below about 1 micron and a particle having a specific gravity of greater than about 2.6.

2. The method of claim 1 wherein the drilling fluid has a density of about 16 pounds per gallon to about 22 pounds per gallon.

3. The method of claim 1 wherein the carrier fluid comprises at least one fluid selected from the group consisting of an aqueous-based fluid and an oleaginous-based fluid.

4. The method of claim 1 wherein the weighting agent is present in the drilling fluid in an amount up to about 50% by volume of the drilling fluid.

5. The method of claim 1 wherein the sub-micron precipitated barite has a particle size distribution such that at least about 90% of particles in the sub-micron precipitated barite have a diameter below about 1 micron.

6. The method of claim 1 wherein the sub-micron precipitated barite has a particle size distribution such at least 10% of particles in the sub-micron precipitated barite has a diameter below about 0.2 micron, at least 50% of the particles in the of the sub-micron precipitated barite has a diameter below about 0.3 micron and at least 90% of the particles in the sub-micron precipitated barite has a diameter below about 0.5 micron.

7. The method of claim 1 wherein the sub-micron precipitated barite is present in the weighting agent in an amount of about 10% to about 90% by weight of the weighting agent.

8. The method of claim 1 wherein the particle having a specific gravity greater than about 2.6 comprises at least one component selected from the group consisting of barite, hematite, ilmenite, manganese tetraoxide, galena, and calcium carbonate.

9. The method of claim 1 wherein a ratio of the sub-micron precipitated barite to the particle having a specific gravity greater than about 2.6 in the weighting agent is about 10:90 to about 90:10.

10. The method of claim 1 wherein a ratio of the sub-micron precipitated barite to the particle having a specific gravity greater than about 2.6 in the weighting agent is about 30:70 to about 70:30.

11. The method of claim 1 wherein the drilling fluid comprises at least one additive selected from the group consisting of a viscosifying agent, a shale inhibitor, a pH-control agent, an emulsifier, a filtration-control agent, calcium hydroxide, and a salt.

12. The method of claim 1 wherein the drilling fluid is essentially free of a viscosifying agent.

13. A method comprising:
extending a well bore into a subterranean formation; and
circulating an invert-emulsion drilling fluid past a drill bit in the well bore, wherein the invert-emulsion drilling fluid comprises a weighting agent comprising:
precipitated barite having a weight average particle diameter below about 1 micron; and
a particle having a specific gravity of greater than about 2.6.

14. The method of claim 13 wherein the drilling fluid has a density of about 16 pounds per gallon to about 22 pounds per gallon

15. The method of claim 13 wherein the sub-micron precipitated barite has a particle size distribution such at least 10% of particles in the sub-micron precipitated barite has a diameter below about 0.2 micron, at least 50% of the particles in the of the sub-micron precipitated barite has a diameter below about 0.3 micron and at least 90% of the particles in the sub-micron precipitated barite has a diameter below about 0.5 micron.

16. The method of claim 13 wherein the sub-micron precipitated barite is present in the weighting agent in an amount of about 10% to about 90% by weight of the weighting agent.

17. The method of claim 13 wherein the particle having a specific gravity greater than about 2.6 comprises manganese tetraoxide in an amount greater than about 90% by weight of the particle.

18. The method of claim 13 wherein a ratio of the sub-micron precipitated barite to the particle having a specific gravity greater than about 2.6 in the weighting agent is about 10:90 to about 90:10.

19. The method of claim 13 wherein a ratio of the sub-micron precipitated barite to the particle having a specific gravity greater than about 2.6 in the weighting agent is about 30:70 to about 70:30.

20. The method of claim 13 wherein the drilling fluid is essentially free of a viscosifying agent.

21. A drilling fluid comprising
a carrier fluid; and
a weighting agent that comprises:
precipitated barite having a weight average particle diameter below about 1 micron; and
a particle having a specific gravity of greater than about 2.6.

22. A weighting agent comprising:
precipitated barite having a weight average particle diameter below about 1 micron; and
a particle having a specific gravity of greater than about 2.6.
